(19) United States
(12) Patent Application Publication
(10) Pub. No.: US 2026/0106499 A1
(43) Pub. Date: Apr. 16, 2026

(54) STATOR OF AN ELECTRIC MACHINE, MOTOR VEHICLE

(71) Applicant: Dr. Ing. h.c. F. Porsche Aktiengesellschaft, Stuttgart (DE)

(72) Inventors: Maximilian CLAUER, Weissach (DE); David BAUER, Asperg (DE)

(21) Appl. No.: 19/346,639

(22) Filed: Oct. 1, 2025

(30) Foreign Application Priority Data
Oct. 14, 2024 (DE) 10 2024 129 605.4

(51) Int. Cl. H02K 1/16; H02K 1/02

(52) U.S. Cl. CPC H02K 1/165; H02K 1/02

(57) ABSTRACT

A stator of an electric machine includes a stator yoke and a stator tooth ring. The stator tooth ring is segmented into planes in an axial direction. Alternately closed stator grooves and semi-open stator grooves are arranged next to one another in a plane in a circumferential direction

### CROSS REFERENCE TO RELATED APPLICATIONS

This application claims benefit to German Patent Application No. DE 102024129 605.4, filed on October 14, 2024, which is hereby incorporated by reference herein.

### FIELD

The present invention relates to a stator of an electric machine, in particular of a traction machine of a motor vehicle. Furthermore, the present invention relates to a motor vehicle having an electric machine.

### BACKGROUND

Modern motor vehicles having an electric machine as a traction machine typically have permanently excited synchronous machines with an internal rotor. The stator surrounds the rotor in the radial direction.

A winding consisting of electrical conductors is arranged in the stator. An electrical current flows through the electrical conductors and generates magnetic fields that interact with the magnets of the rotor and result in rotation of the rotor. The winding is a hairpin winding with rectangular profile wire conductors, for example. The electrical conductors of the winding are arranged in stator grooves of the stator, which extend along the axial direction of the electrical machine.

Typically, the stator is assembled from a stator laminated core. The stator laminated core consists of individual axially stacked electrically insulated stator laminations, which are welded or axially bonded to the radial outer side, for example. The stator grooves are arranged towards the inside of the stator. There are different variants of stator grooves here. Open stator grooves are fully open to the air gap, i.e., to the area between stator and rotor, wherein the winding inside the stator groove is spaced apart from the air gap. There is no stator iron plate between the conductors in the open stator groove and the air gap. Closed stator grooves completely enclose the conductors in the radial direction. The stator plate extends between the conductor and the air gap when the stator grooves are closed, so that there is no passage between the stator groove and the air gap in the radial direction. With semi-open stator grooves, the stator plate is interrupted between the electrical conductors and the air gap, so that the semi-open stator groove is open towards the air gap, but not across its full width.

The geometrical design of the stator grooves has a significant impact on the characteristics of the electric machine. Thus, an electric machine with open stator grooves is more powerful than the same machine with closed stator grooves. An electric machine with semi-closed stator grooves typically results in the highest maximum torque and a higher maximum power than the closed stator groove, but to a lower maximum power than the open stator groove. However, the higher power of the semi-closed and open stator grooves comes at the price of greater stronger torque ripple, which can lead to increased acoustic pollution.

### SUMMARY

In an embodiment, the present disclosure provides a stator of an electric machine, including a stator yoke; and a stator tooth ring. The stator tooth ring is segmented into planes in an axial direction. Alternately closed stator grooves and semi-open stator grooves are arranged next to one another in a plane in a circumferential direction.

### BRIEF DESCRIPTION OF THE DRAWINGS

FIGS. 1 (a)–(c) schematically illustrate the manufacture of a stator in accordance with an exemplary embodiment of the present invention;

FIG. 2 schematically illustrates a detail of a stator according to an exemplary embodiment of the present invention;

FIG. 3 schematically illustrates a detail of a stator according to an exemplary embodiment of the present invention; and

FIG. 4 schematically illustrates a motor vehicle according to an exemplary embodiment of the present invention.

### DETAILED DESCRIPTION

Embodiments of the present invention provide a stator of an electric machine and a motor vehicle having an electric machine which do not have the aforementioned disadvantages of the prior art, but combine high maximum power and a high maximum torque with low acoustic pollution.

The stator of an electric machine according to an embodiment of the present invention is in particular a stator of an electric traction machine of a motor vehicle. The stator comprises a stator yoke and a stator tooth ring. The stator yoke and stator tooth ring are provided as separate parts. The stator yoke surrounds the stator tooth ring in the radial direction on the outside. The stator tooth ring is segmented into planes in the axial direction of the stator. The planes of the stator tooth ring may be welded together, bonded, or compressed. It is also contemplated that the stator yoke is segmented into planes in the axial direction. According to embodiments of the invention, it is provided that in the circumferential direction of the stator, alternately closed stator grooves and semi-open stator grooves are arranged next to one another. The mixture of closed and semi-open stator grooves ensures an excellent compromise between maximum power, maximum torque, and low acoustic pollution.

Advantageous embodiments and further developments of the invention can be found in the description, with reference to the drawings.

According to a preferred embodiment of the present invention, it is contemplated that alternately closed stator grooves and semi-open stator grooves are arranged next to one another in parallel to the axial direction. In other words, alternately closed and semi-open stator grooves are provided not only in the circumferential direction, but also in the axial direction. This reduces the torque ripple even further.

A particularly preferred embodiment of the present invention is one in which it is provided that the stator tooth ring is made of a grain-oriented sheet metal in the radial direction. In preferred embodiment, the stator tooth ring is made of a cobalt-iron material or a silicon-iron material. In the stator teeth, the magnetic flux is essentially aligned along the radial direction during operation of the electric machine. This is taken into account by the grain orientation in the radial direction, which can increase the maximum achievable torque. For example, the grain orientation may be affected by the rolling direction during the manufacture of the corresponding components.

According to a further preferred embodiment of the present invention, it is contemplated that the stator yoke is made of non-grain-oriented electric sheet. There is a constant change in direction of the magnetic flux in the stator yoke. A grain orientation would make this more difficult. The lack of grain orientation in the stator yoke therefore helps to further increase the maximum achievable torque.

According to a further preferred embodiment of the present invention, it is contemplated that the planes are segmented in stator tooth elements along the circumferential direction. The stator tooth elements each have at least two stator teeth. The stator teeth of a stator tooth element are spaced apart by a groove spacing in the circumferential direction. A closed stator groove is formed between the stator teeth of a stator tooth element. The stator tooth element has a circular arc on the inside in the radial direction, following the circumferential direction in its main direction of extension. The circular arc closes off the closed stator groove inwards in the radially inward direction and is arranged along and against the circumferential direction extending beyond the stator teeth by a distance. The distance is less than half the groove spacing. This makes it advantageously possible to provide the stator tooth ring by arranging similar stator tooth elements, making the manufacturing process cost-effective and very efficient.

For this purpose, in preferred embodiments, it is provided that the extent of the circular arc in the radial direction is greater than twice the thickness of the stator tooth element along the axial direction. In this manner, stacking the stator tooth elements results in favorable geometry of the stator.

According to a further preferred embodiment of the present invention, the stator tooth elements of a plane are arranged such that the distance between the adjacent stator teeth of adjacent stator tooth elements corresponds to the groove width, thereby forming a semi-open stator groove between the adjacent stator tooth elements. In this way, it is advantageously easy to manufacture a stator tooth ring having an alternately arranged closed and semi-open stator groove.

For this purpose, in preferred embodiments, it is provided that planes adjacent in the axial direction are arranged rotated relative to one another about the central axis of the stator in such a way that the stator teeth of the stator tooth elements are positioned one above the other in the axial direction, and that the closed stator groove of one stator tooth element and the semi-open stator groove of an axially adjacent stator tooth element adjacent are likewise positioned one above the other. This is a simple way of providing a stator in which the stator slots alternate between closed and semi-open areas along the axial direction.

According to a further preferred embodiment of the present invention, it is contemplated that the stator tooth ring and the stator yoke are positively connected to one another, preferably with centering ribs of the stator yoke being engaged in centering grooves of the stator teeth. This ensures that the stator teeth are securely arranged in a fixed position, in particular embodiments in a torsion-resistant manner, which significantly simplifies the manufacture of the stator and reduces mechanical stresses and thus voltage-related increased remagnetization losses. For this purpose, the stator number elements are, in preferred embodiments, arranged in relation to the stator tooth ring. The stator tooth elements are arranged in planes along the circumferential direction and the planes are stacked. The stator tooth elements and/or the planes can be welded, pressed, and/or bonded together. Then, the conductors of the winding are inserted into the stator grooves. Finally, the stator tooth ring with the conductors of the winding, which is advantageously designed as a continuous shaft winding and is inserted radially outward, is pushed axially into the stator yoke and fixed in it.

A further embodiment of the present invention for solving the initially formulated problem is a motor vehicle comprising an electric machine with a stator according to an embodiment of the invention.

All details, features, and advantages previously disclosed in connection with the stator according to embodiments of the invention also relate to the motor vehicle according to embodiments of the invention.

Further details, features, and advantages of embodiments of the invention can be found in the drawings as well as from the following description of preferred embodiments based on the drawings. The drawings illustrate only exemplary embodiments of the invention, which do not restrict the concept of the invention.

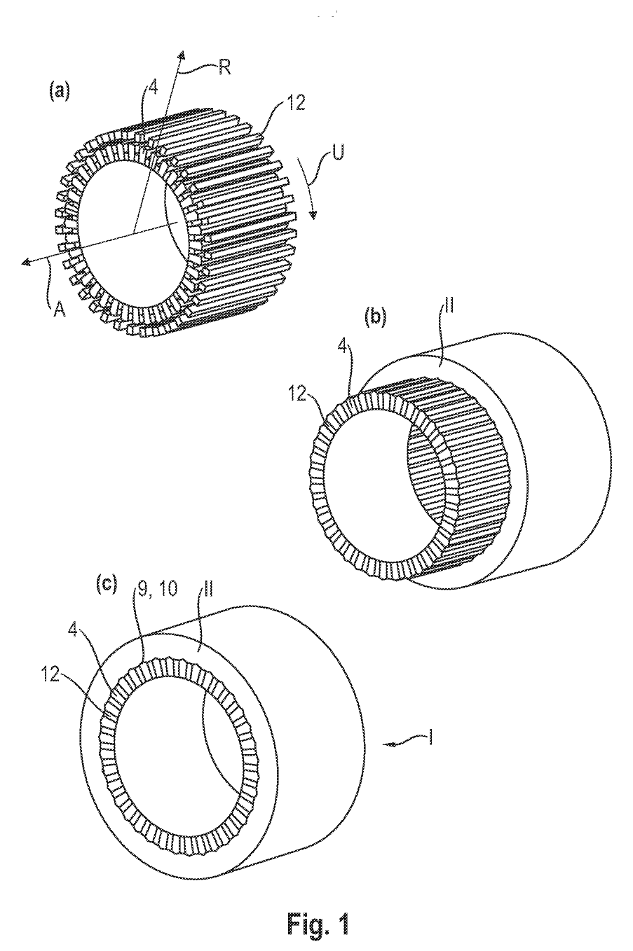

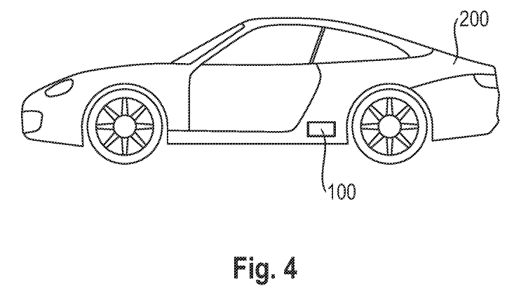

FIGS. 1 (a)–(c) schematically illustrate the manufacture of a stator 1 in accordance with an exemplary embodiment of the present invention. The stator 1 is a stator 1 of an electric machine 100 (see FIG. 4). In the embodiment illustrated herein, the electric machine 100 is a traction machine of a motor vehicle 200.

The electric machine 200 includes the stator 1, which circumscribes a rotor of the electric machine 200 relative to a radial direction R. The stator 1 is divided into a stator yoke 11 and a stator tooth ring 4. The stator tooth ring 4 has a plurality of planes 8 which are stacked along an axial direction A. In each plane 8, the stator tooth ring 4 is assembled from a plurality of stator tooth elements 5 (see FIG. 3).

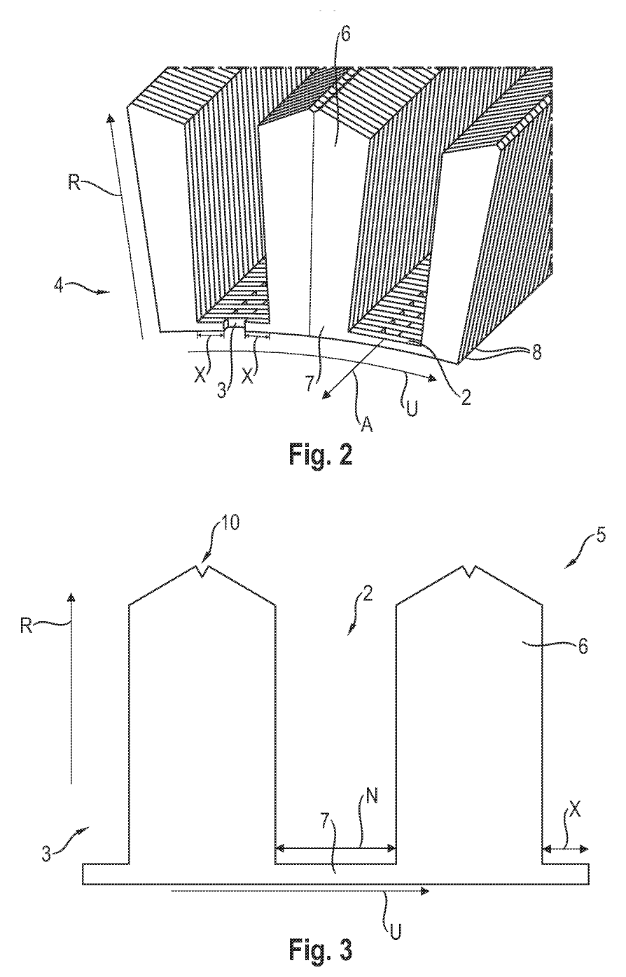

Each of the stator tooth elements 5 comprises at least two stator teeth 6. The stator teeth 6 are spaced apart by a groove spacing N. While the area between the stator teeth 6 is closed off by the stator yoke 11 in the radial direction R on the outside, the area between the stator teeth 6 of a stator tooth element 5 is closed off by a circular arc 7 in the radial direction R on the inside. FIG. 3 is strongly schematic, so that the circular arc 7 is not shown in circular arcs, but rather in rectangular form. A more realistic representation of a part of the circular arc 7 can be found in FIG. 2.

The radially inner end of the area between the stator teeth 6 forms a closed stator slot 2. The circular arc 7 extends in the circumferential direction by a direction X beyond the stator teeth 6 of the stator tooth element 5, wherein the distance X is smaller than half the groove spacing N. To form a plane 8, a plurality of stator tooth elements 5 are arranged such that the adjacent stator teeth 6 of adjacent stator tooth elements 5 are arranged at the groove spacing N. A semi-open stator groove 3 is now formed between the adjacent stator tooth elements 5.

In FIG. 2, it can be seen that the closed stator grooves 2 and semi-open stator grooves 3 formed in this way alternate in a plane 8 along the circumferential direction U. Further, the planes 8 are displaced against each other such that stator grooves 2 and semi-open stator grooves 3 are alternated along the axial direction A. The term “stator groove” in the context of this text deviates from what the person skilled in the art typically understands herein. In the context of embodiments of the present invention, a closed or semi-open stator groove 2, 3 refers to the area of a plane 8. The space for accommodating a conductor 12 of a winding, which is continuous in the axial direction A, is thus composed of several stator grooves 2, 3 in the linguistic usage of the present invention.

After assembly of the stator ring 4 from the planes 8, which in turn are composed of the stator tooth elements 5, the conductors 12 of the winding are inserted into the stator grooves 2, 3. The stator tooth ring 4 is then inserted into the stator yoke 11 along the axial direction A. The secure arrangement of the stator teeth 6 is supported by centering grooves 10 on the stator teeth 6 and centering ribs 9 on the stator yoke 11, which engage in the centering grooves 10. In particular embodiments, mechanical stresses are reduced, which reduces remagnetization losses.

In order to take the magnetic flux in the stator 1 into account as well as possible, the electric sheet of the stator tooth elements 5 is machined so as to have a grain orientation in the radial direction R. In contrast, the electrical sheet of the stator yoke 11 has no grain orientation. This significantly increases the maximum achievable torque of the electric machine 200. The arrangement of the closed and semi-open stator grooves 2, 3 noticeably improves the torque ripple. Finally, the segmented design of the stator 1 shown provides for ease of manufacture and minimal waste during production.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A stator of an electric machine, comprising:
a stator yoke; and
a stator tooth ring,
wherein the stator tooth ring is segmented into planes in an axial direction, and
wherein alternately closed stator grooves and semi-open stator grooves are arranged next to one another in a plane in a circumferential direction.

2. The stator according to claim 1, wherein the alternately closed stator grooves and semi-open stator grooves are arranged next to one another in parallel to the axial direction.

3. The stator according to claim 1, wherein the stator tooth ring is made of a grain-oriented electrical sheet in a radial direction, wherein the stator tooth ring is made of a cobalt-iron material or a silicon-iron material.

4. The stator according to claim 1, wherein the stator yoke is made of non-grain-oriented electrical sheet.

5. The stator according to claim 1, wherein the planes are segmented along the circumferential direction into stator tooth elements, wherein the stator tooth elements each comprise at least two stator teeth, wherein the stator teeth of a respective stator tooth element are spaced apart in the circumferential direction by a groove spacing and a closed groove is formed between the stator teeth of the respective stator tooth element, wherein the respective stator tooth element has a circular arc on an inside in a radial direction following the circumferential direction in a main direction of extension, wherein the circular arc closes off the closed groove inwards in the radial direction and is arranged along and against the circumferential direction beyond the stator teeth by a distance, wherein the distance is smaller than half the groove spacing.

6. The stator according to claim 5, wherein an extent of the circular arc in the radial direction is greater than twice a thickness of the respective stator tooth element along the axial direction.

7. The stator according to claim 5, wherein the stator tooth elements of a respective plane are arranged such that a distance between adjacent stator teeth of adjacent stator tooth elements are spaced apart by a groove width, such that a semi-open groove is formed between the adjacent stator tooth elements.

8. The stator according to claim 7, wherein planes adjacent in the axial direction are arranged rotated relative to one another about a central axis of the stator, such that the stator teeth of the respective stator tooth elements lie one above the other in the axial direction and that the closed groove of the stator tooth element and the semi-opened groove of a stator tooth element adjacent in the axial direction lie one above the other.

9. The stator according to claim 1, wherein the stator tooth ring and the stator yoke are connected to each other in a positive manner, and wherein centering ribs of the stator yoke are arranged so as to engage in centering grooves of stator teeth, the stator tooth elements comprising the stator teeth.

10. A motor vehicle comprising an electric motor comprising the stator according to claim 1.

11. The stator according to claim 1, wherein the electric machine is a traction machine of a motor vehicle.
